(19) United States
(12) Patent Application Publication
(10) Pub. No.: US 2023/0297740 A1
(43) Pub. Date: Sep. 21, 2023

(54) UNIFORM RADIATION HEATING CONTROL ARCHITECTURE

(71) Applicant: Applied Materials, Inc., Santa Clara, CA (US)

(72) Inventors: Preetham Rao, Morgan Hill, CA (US); Surajit Kumar, San Jose, CA (US); Dongming Iu, Union City, CA (US); Wolfgang Aderhold, Santa Clara, CA (US)

(21) Appl. No.: 17/695,619

(22) Filed: Mar. 15, 2022

(51) Int. Cl. G06F 30/27; G06K 9/62

(52) U.S. Cl. CPC G06F 30/27; G06K 9/6256; G06F 2119/08

(57) ABSTRACT

Embodiments disclosed herein include a method of modeling a rapid thermal processing (RTP) tool. In an embodiment, the method comprises developing a lamp model of an RTP tool, wherein the lamp model comprises a plurality of lamp zones, calculating an irradiance graph for the plurality of lamp zones, multiplying irradiance values of the plurality of lamp zones in the irradiance graph by a power of an existing RTP tool at a given time during a process recipe, summing the multiplied irradiance values for the plurality of lamp zones to form an irradiation graph of the lamp model, using the irradiation graph as an input to a machine learning algorithm, and outputting the temperature across a hypothetical substrate from the machine learning algorithm.

### BACKGROUND

### 1) Field

Embodiments relate to the field of semiconductor manufacturing and, in particular, a process for estimating thermal uniformity across a substrate in a modeled tool.

### 2) Description of Related Art

In semiconductor processing environments, rapid thermal processing (RTP) tools are used, for example, in order to execute thermal treatments (e.g., anneals) and grow material layers (e.g., oxidation growth), to name a couple applications. In an RTP tool, an array of lamps are used in order to heat a substrate that is positioned below the lamps. A reflector may also be provided below the substrate in some instances. Temperature control across the surface of the substrate is a critical parameter of RTP tools. Often the temperature is desired to be substantially uniform across the diameter of the substrate.

In order to control the temperature, RTP tools often include lamps that are grouped into a plurality of zones. The lamps in a single zone may be supplied with the same amount of power, and the different zones may have different power levels. For example, the power of a zone near the center of the substrate may be different than the power of a zone towards the edge of the substrate.

Control of the temperature across the substrate is a complex engineering obstacle. While positioned above a certain region of the substrate, the lamp irradiation may also heat up neighboring regions of the substrate. Thermal modeling also needs to take into account chamber wall temperatures, edge ring temperatures, reflector material, substrate material, among many other parameters.

Accordingly, it is exceedingly difficult to model RTP tools. Additionally, models that are made are computationally intensive, and require long periods of time in order to generate the thermal behavior within a system. Due to the complexity of forming such models, it is difficult to model new RTP tool designs. For example, it may be desirable to reduce the number of lamps in an RTP tool (e.g., for decreased manufacturing cost, reductions in consumed power, etc.). However, existing solutions limit the ability to test new designs before they are implemented in a physical form.

### SUMMARY

Embodiments disclosed herein include a method of modeling a rapid thermal processing (RTP) tool. In an embodiment, the method comprises developing a lamp model of an RTP tool, wherein the lamp model comprises a plurality of lamp zones, calculating an irradiance graph for the plurality of lamp zones, multiplying irradiance values of the plurality of lamp zones in the irradiance graph by a power of an existing RTP tool at a given time during a process recipe, summing the multiplied irradiance values for the plurality of lamp zones to form an irradiation graph of the lamp model, using the irradiation graph as an input to a machine learning algorithm, and outputting the temperature across a hypothetical substrate from the machine learning algorithm.

Embodiments may also include a non-transitory computer readable medium containing program instructions for causing a computer to perform a method. In an embodiment, the method comprises developing a lamp model of an RTP tool, wherein the lamp model comprises a plurality of lamp zones, calculating an irradiance graph for the plurality of lamp zones, multiplying irradiance values of the plurality of lamp zones in the irradiance graph by a power of an existing RTP tool at a given time during a process recipe, summing the multiplied irradiance values for the plurality of lamp zones to form an irradiation graph of the lamp model, using the irradiation graph as an input to a machine learning algorithm, and outputting the temperature across a hypothetical substrate from the machine learning algorithm.

Embodiments may also include a method of modeling a rapid thermal processing (RTP) tool. In an embodiment, the method comprises training a machine learning algorithm with training data that includes real temperature data from an existing RTP tool, developing a lamp model of an RTP tool, wherein the lamp model comprises a plurality of lamp zones, and wherein a number of lamps in the lamp model is different than a number of lamps in the existing RTP tool, calculating an irradiance graph for the plurality of lamp zones, multiplying irradiance values of the plurality of lamp zones in the irradiance graph by a power of the existing RTP tool at a given time during a process recipe, summing the multiplied irradiance values for the plurality of lamp zones to form an irradiation graph of the lamp model, using the irradiation graph as an input to the machine learning algorithm, and outputting the temperature across a hypothetical substrate from the machine learning algorithm.

### BRIEF DESCRIPTION OF THE DRAWINGS

FIG. 1A is a plan view illustration of a lamp array for an existing rapid thermal processing (RTP) tool, in accordance with an embodiment.

FIG. 1B is a plan view illustration of a lamp array for a RTP tool that is being investigated with a processing method described herein, in accordance with an embodiment.

FIG. 2 is a graph of the irradiance of a lamp array on a substrate, where the lamp array has a plurality of zones, in accordance with an embodiment.

FIG. 3A is a graph of the power applied to lamps within certain groups over the duration of a processing recipe, in accordance with an embodiment.

FIG. 3B is a graph of the temperature of a substrate at different locations over the duration of a processing recipe, in accordance with an embodiment.

FIG. 3C is a graph of the temperature across a radius of the substrate that is used as a training data set, in accordance with an embodiment.

FIG. 4 is a graph of the irradiation across a radius of the substrate that is used as an input for a machine learning (ML) algorithm, in accordance with an embodiment.

FIG. 5 is a schematic of a ML algorithm used to convert input irradiation across the substrate into an output of temperature across the substrate, in accordance with an embodiment.

FIG. 6 is a process flow diagram that depicts a process for determining the temperature profile of a hypothetical substrate heated in an RTP tool that is being modeled, in accordance with an embodiment.

FIG. 7 illustrates a block diagram of an exemplary computer system that may be used in conjunction with a processing tool, in accordance with an embodiment.

### DETAILED DESCRIPTION

Systems described herein include a process for estimating thermal uniformity across a substrate in a modeled tool. In the following description, numerous specific details are set forth in order to provide a thorough understanding of embodiments. It will be apparent to one skilled in the art that embodiments may be practiced without these specific details. In other instances, well-known aspects are not described in detail in order to not unnecessarily obscure embodiments. Furthermore, it is to be understood that the various embodiments shown in the accompanying drawings are illustrative representations and are not necessarily drawn to scale.

As noted above, it is currently difficult to model rapid thermal processing (RTP) tools that are being developed. Accordingly, it is not currently feasible to determine the substrate temperature profile on a design without using an overly complex model or actually building the RTP tool. This leads to excess waste of resources and time. This is particularly problematic when redesigns of the RTP tool are needed. For example, it may be desirable to reduce the number of lamps in the lamp array in order to reduce costs and/or reduce power consumption.

Therefore, embodiments disclosed herein include methods in order to generate the temperature profile using machine learning (ML) algorithms. Generally, a new lamp design is created. The irradiance of the lamps on the substrate is calculated. This provides a graph of the irradiance supplied by a plurality of lamp zones. The irradiance can then be multiplied by a power in a recipe that is supplied to the individual zones. The resulting values of each zone can then be summed together in order to provide a graph of the irradiation across the surface of the substrate. In an embodiment, the irradiation values may then be inputted into a ML algorithm. The ML algorithm may output a temperature profile for the RTP tool being investigated. As such, there is no need to extensively model or build an RTP tool in order to determine temperature profiles.

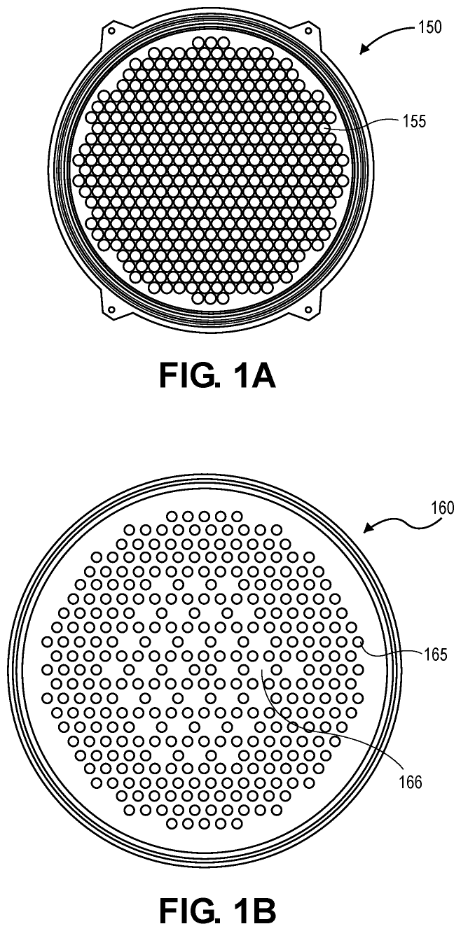

Referring now to FIG. 1A, a plan view illustration of a lamp array 150 of a RTP tool is shown, in accordance with an embodiment. As shown, the lamp array 150 includes a plurality of lamps 155 that are arranged in a given pattern. For example, the pattern may be a honeycomb shaped pattern. Each of the lamps 155 in the lamp array 150 may be powered in order to heat up an underlying substrate (not shown). The substrate may be a semiconductor substrate, such as, a silicon wafer or the like. Though, it is to be appreciated that other substrates may be used as well (e.g., glass substrates or the like).

In an embodiment, the lamps 155 may be separated into a plurality of groups (also referred to as zones). The zones may be substantially concentric zones. In a simple case, a first zone may be a central zone, and a second zone may be the group of lamps 155 outside of the first zone. However, it is to be appreciated that in more complex tools, the number of zones may be significantly higher. For example, there may be up to 15 (or more) zones in a given lamp array.

For purposes of convenience, the lamp array 150 may be considered herein as a physical lamp array 150. That is, the lamp array 150 may be an existing array that has already been designed and assembled. The lamp array 150 may be used for training purposes in order to teach machine learning (ML) algorithms in order to aid in the development of new RTP architectures.

Referring now to FIG. 1B, a plan view illustration of a lamp array 160 is shown, in accordance with an additional embodiment. As shown, the lamp array 160 may comprise a plurality of lamps 165. The arrangement (and/or number) of lamps 165 in the lamp array 160 may be different than the number and/or arrangement of lamps 155 in the lamp array 150 described above. For example, in the lamp array 160, there are fewer lamps 165 than the number of lamps 155 in the lamp array 150. Additionally, there are vacancies 166 where there is no lamp 165. Other than the vacancies 166, the lamps 165 may be arranged in a honeycomb type arrangement. Though, it is to be appreciated that other arrangements (e.g., different packing schemes, different spacings (or pitch) etc.) may be used.

As will be described in greater detail below, the lamp array 160 may be a theoretical or hypothetical lamp array 160. That is, the lamp array 160 may not be physically built. However, as a result of analysis methods, such as those described in greater detail below, the lamp array 160 can be analyzed in order to determine the temperature profile that will be implemented on a substrate. As such, the output of the RTP tool can be characterized and compared to existing solutions in order to determine if the design should be built out into an actual product. This saves design time and costs, since underperforming lamp arrays 160 can be dismissed from consideration.

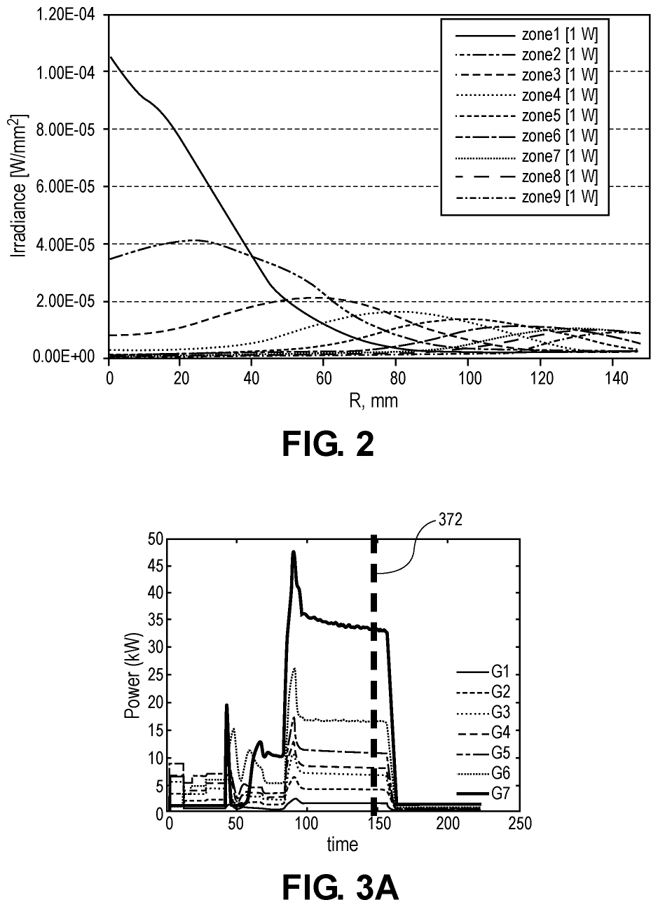

Referring now to FIG. 2, a graph of the irradiance of the lamps 165 across the surface of a substrate is shown, in accordance with an embodiment. The irradiance shown in FIG. 2 is broken into a set of nine zones. Each zone may include a plurality of individual lamps 165. While nine zones are shown in FIG. 2, it is to be appreciated that the lamps 165 may be grouped into any number of zones (e.g., two or more zones). In a particular embodiment, there may be fourteen zones. The irradiances may be calculated irradiances. That is, the irradiances may not necessarily be a measured quantity. As such, the graph shown in FIG. 2 may be generated without needing to actually fabricate the lamp array 160. In an embodiment, the irradiance values (Y-axis) are plotted against a radius of the substrate (X-axis). For example, the X-axis may extend from 0 mm (i.e., the center of the substrate) to approximately 150 mm (i.e., the edge of the substrate). In such an embodiment, the substrate is a 300 mm substrate. However, it is to be appreciated that substrates with other form factors may also be used in accordance with other embodiments.

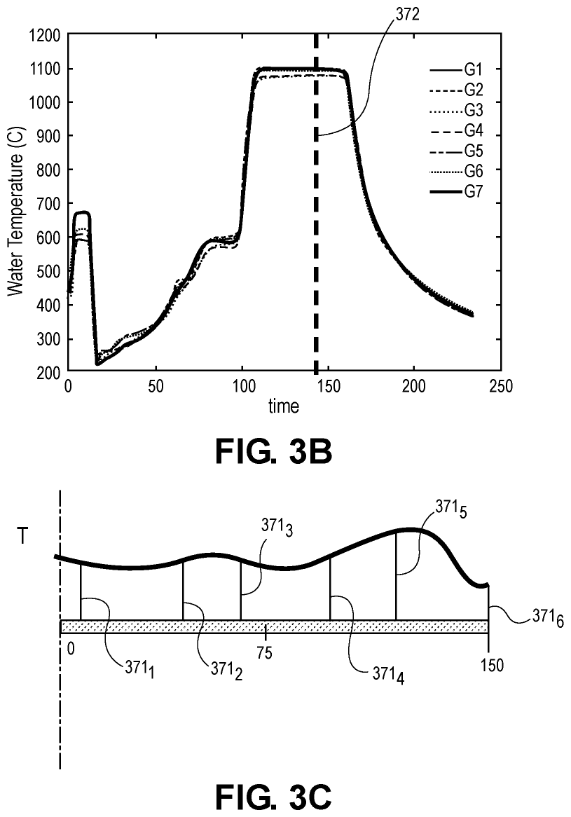

Referring now to FIG. 3A, a graph of the power of different lamp groups as a function of time is shown, in accordance with an embodiment. In an embodiment, the graph in FIG. 3A may be a graph of a physical system. That is, the system that is being shown in FIG. 3A may actually be built. For example, a lamp array similar to lamp array 150 may be used to generate the graph in FIG. 3A. In FIG. 3A, seven groups are shown. However, it is to be appreciated that any number of groups (e.g., two or more groups) may be used in accordance with an embodiment. Each group may include two or more lamps, such as lamps 155 described above.

The graph in FIG. 3A may be the graph of power during the duration of process recipe. For example, the process recipe may have a duration that is approximately 225 seconds. However, it is to be appreciated that the process recipe may have any duration in order to provide a desired result on the substrate. As shown, the process recipe may include a thermal ramp up region at around 70 seconds. The thermal ramp up region represents a rapid increase in the temperature of the substrate. After the ramp up region, a thermal soak is implemented. The thermal soak is a period of time where the substrate is held at a substantially constant elevated temperature. After the desired time of the thermal soak, a thermal ramp down region returns the temperature of the substrate back to a room temperature.

In the illustrated embodiment, group 1 (G1) may be at a center of the substrate and group 7 (G7) may be at an edge of the substrate. As shown, group 7 may have the highest power during the thermal soak, and group 1 may have the lowest power during the thermal soak. The remaining groups (G2-G6) may have powers between group 1 and group 7.

Referring now to FIG. 3B, a graph of the substrate temperature during the duration of the recipe is shown, in accordance with an embodiment. In an embodiment, the temperature graph may include a plurality of groups (e.g., G1-G7). The groups G1 to G7 may be substantially similar to the groups G1-G7 described above with respect to FIG. 3A. As such, while seven groups are shown, it is to be appreciated that any number of groups (e.g., two or more groups) may be used in accordance with an embodiment. As shown, the temperatures of G1 to G7 are substantially uniform with each other, despite having significantly different power levels (as shown in FIG. 3A). As illustrated, there is a thermal ramp at approximately 100 seconds, which is followed by a thermal soak between approximately 110 seconds and approximately 160 seconds.

Referring now to FIG. 3C, a graph of the temperature of the substrate at a given time is shown, in accordance with an embodiment. The Y-axis may refer to the temperature, and the X-axis may refer to the distance from the center of the substrate. As shown, six positions 371₁-371₆ are illustrated. Each of the positions 371 may be the location of a pyrometer that measures the temperature of the substrate at that location. In an embodiment, the portion of the curves between the six positions 371 may be a fitted line. That is, there may not be actual temperature measurements between the positions 371.

In a particular embodiment, the moment in time that the graph in FIG. 3C represents may be where the dashed lines 372 are shown in FIGS. 3A and 3B. For example, the snapshot of temperature in FIG. 3C may be at around 150 seconds in the process recipe. That is, the time may be around the end of the thermal soak in some embodiments. However, it is to be appreciated that the temperature snapshot may be provided at any time during the process recipe.

In an embodiment, the temperature snapshot in FIG. 3C may be used as a training data set. For example, a machine learning (ML) algorithm described in greater detail below may utilize the temperature snapshot and the other data in FIGS. 3A and 3B as a set of training data. The snapshot in FIG. 3C may be the output value, and the other data from the graphs in FIGS. 3A and 3B may be used as input data.

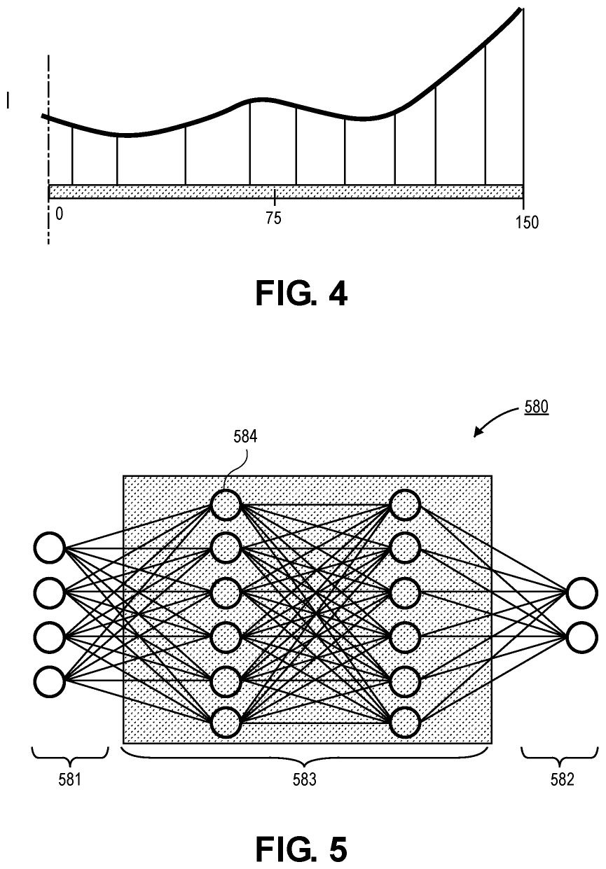

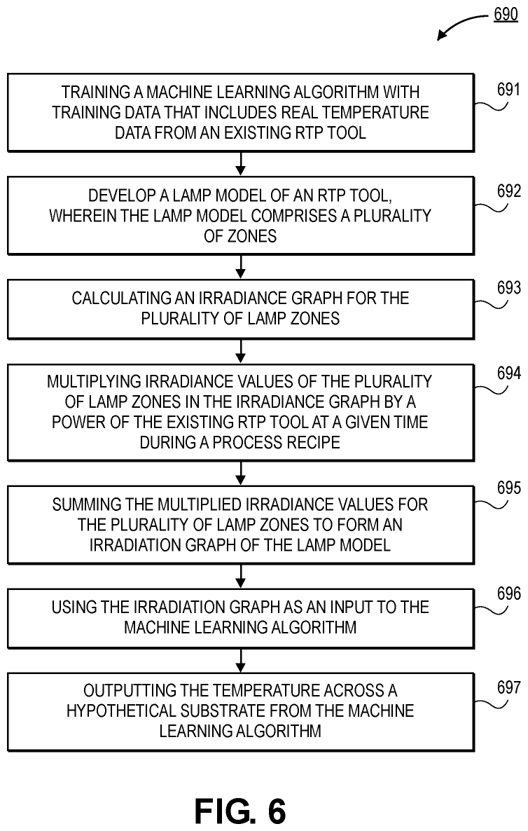

Referring now to FIG. 4, a graph of irradiation versus position across the substrate is shown, in accordance with an embodiment. In an embodiment, the graph in FIG. 4 is generated from the data in the irradiance graph of FIG. 2. Particularly, the irradiance values in FIG. 2 are multiplied by the power values in FIG. 3A at the time of the dashed line 372. After the irradiance values are multiplied, each of the groups are summed together in order to provide the irradiation value. This irradiation value shown in FIG. 4 can then be used as an input to the ML algorithm in order to output a temperature snapshot, similar to the embodiment shown in FIG. 3C. In this way, a prediction of the temperature uniformity can be made without actually having to build and test a lamp array. A more detailed explanation of the process for generating a temperature uniformity plot is described in greater detail below with respect to FIG. 6.

Referring now to FIG. 5, a schematic illustration of a ML algorithm 580 is shown, in accordance with an embodiment. In an embodiment, the ML algorithm may include an input side 581 and an output side 582. A plurality of hidden layers 583 may be provided between the input side 581 and the output side 582. The hidden layers 583 may each include a plurality of nodes 584 that are communicatively coupled to each other (as indicated by the lines between the nodes). In an embodiment, two hidden layers 583 are shown. However, it is to be appreciated that any number of hidden layers may be used, depending on the complexity of the ML algorithm.

In an embodiment, the ML algorithm takes irradiation values as an input (e.g., similar to the graph shown in FIG. 4), and outputs a temperature uniformity plot (e.g., similar to the graph shown in FIG. 3C). The structure of the ML algorithm may be any type of ML algorithm. For example, the ML algorithm may be a supervised ML algorithm, a semi-supervised ML algorithm, an unsupervised ML algorithm, a reinforcement ML algorithm, or the like.

Referring now to FIG. 6, a process flow diagram depicting a process 690 for modeling a RTP tool is shown, in accordance with an embodiment. In an embodiment, the process 690 may begin with operation 691 which comprises training an ML algorithm with training data that includes real temperature data from an existing RTP tool. For example, the training data may be obtained from a RTP tool with a lamp array similar to the lamp the lamp array 150 described in greater detail above. The training data may include information on power supplied to various lamp zones in the lamp array, the temperature of the various zones over time, and a snapshot of the temperature across the substrate at a given time. For example, the snapshot of the temperature across the substrate may be similar to the snapshot graph shown in FIG. 3C. The snapshot of the temperature across the substrate may be the output value of the ML algorithm, and the other data may be fed as input data to the ML algorithm. In some embodiments, there may be more than one training data set used. For example, there may be up to 25 or more training data sets in order to properly train the ML algorithm.

In an embodiment, the process 690 may continue with operation 692, which comprises developing a lamp model of an RTP tool. In an embodiment, the lamp model of the RTP tool may have a different configuration than the lamp array of the existing RTP tool used for the ML algorithm training process. For example, the lamp model may have a lamp array with a different layout of the individual lamps and/or a different number of lamps in the lamp array. In a particular embodiment, the RTP tools being investigated are desired to have the same or similar performance as the existing RTP tool while including fewer lamps in order to enable cost and power reductions.

In an embodiment, the process 690 may continue with operation 693, which comprises calculating an irradiance graph for a plurality of zones for the lamp model. In an embodiment, the irradiance graph may be similar to the graph shown in FIG. 2 above. That is, a plurality of different zones and their irradiance across the surface of the substrate is provided. The irradiance may be calculated. Since the values are calculated, there is no need to physically build the lamp model.

In an embodiment, the process 690 may continue with operation 694, which comprises multiplying irradiance values of the plurality of lamp zones in the irradiance graph by a power of the existing RTP tool at a given time during a process recipe. For example, the power values may be provided by a graph, such as the graph shown in FIG. 3A. The given time may refer to the dashed line 372. For example, the power levels may be during the thermal soak. In other embodiments, the power levels used may be during the thermal ramp. In yet another embodiment, the power at a plurality of different times are multiplied by the irradiance values.

In an embodiment, the process 690 may continue with operation 695, which comprises summing the multiplied irradiance values for the plurality of lamp zones to form an irradiation graph of the lamp model. The irradiation graph of the lamp model may be similar to the graph shown in FIG. 4. That is, irradiation across the surface of the substrate may be provided. In embodiments, where the power at a plurality of different times are multiplied by the irradiance values, there may be multiple irradiation graphs provided.

In an embodiment, the process 690 may continue with operation 696, which comprises using the irradiation graph (or graphs) as an input to the ML algorithm. The irradiation graph (or graphs) may be inputted in the ML algorithm that was trained in operation 691. In an embodiment, the process 690 may continue with operation 697, which comprises outputting the temperature across a hypothetical substrate from the machine learning algorithm. As such, the performance of the RTP tool can be determined without the need to build the model of the RTP tool. Accordingly, many different models may be easily investigated using a similar process in order to select the best candidates for further consideration with minimal cost and development time.

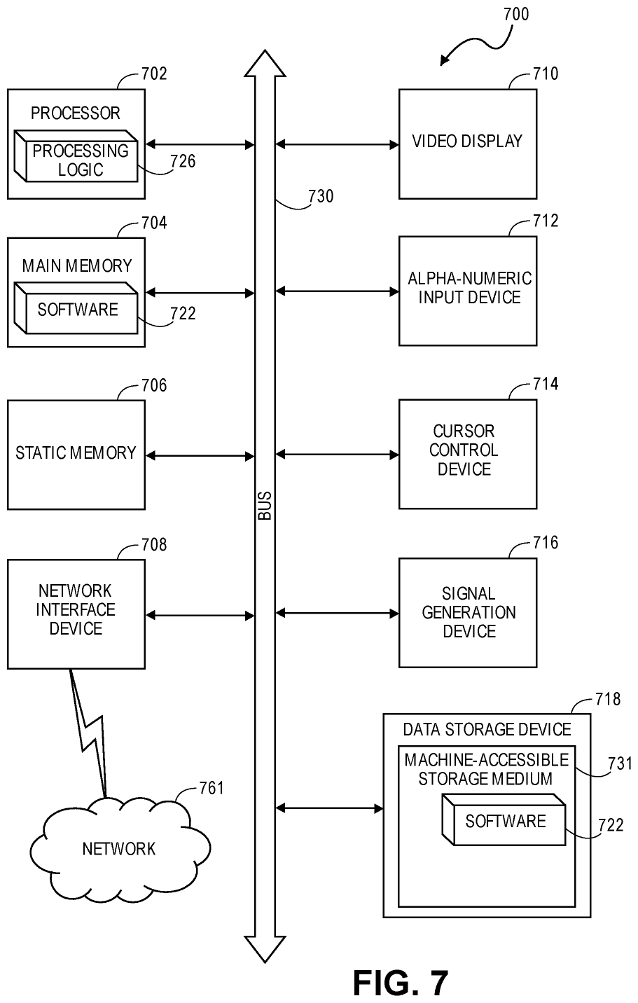

Referring now to FIG. 7, a block diagram of an exemplary computer system 700 of a processing tool is illustrated in accordance with an embodiment. In an embodiment, computer system 700 is coupled to and controls processing in the processing tool. Computer system 700 may be connected (e.g., networked) to other machines in a Local Area Network (LAN), an intranet, an extranet, or the Internet. Computer system 700 may operate in the capacity of a server or a client machine in a client-server network environment, or as a peer machine in a peer-to-peer (or distributed) network environment. Computer system 700 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 700, the term “machine” shall also be taken to include any collection of machines (e.g., computers) that individually or jointly execute a set (or multiple sets) of instructions to perform any one or more of the methodologies described herein.

Computer system 700 may include a computer program product, or software 722, having a non-transitory machine-readable medium having stored thereon instructions, which may be used to program computer system 700 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 700 includes a system processor 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a secondary memory 718 (e.g., a data storage device), which communicate with each other via a bus 730.

System processor 702 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 702 may also be one or more special-purpose processing devices such as an application specific integrated circuit (ASIC), a field programmable gate array (FPGA), a digital signal system processor (DSP), network system processor, or the like. System processor 702 is configured to execute the processing logic 726 for performing the operations described herein.

The computer system 700 may further include a system network interface device 708 for communicating with other devices or machines. The computer system 700 may also include a video display unit 710 (e.g., a liquid crystal display (LCD), a light emitting diode display (LED), or a cathode ray tube (CRT)), an alphanumeric input device 712 (e.g., a keyboard), a cursor control device 714 (e.g., a mouse), and a signal generation device 716 (e.g., a speaker).

The secondary memory 718 may include a machine-accessible storage medium 732 (or more specifically a computer-readable storage medium) on which is stored one or more sets of instructions (e.g., software 722) embodying any one or more of the methodologies or functions described herein. The software 722 may also reside, completely or at least partially, within the main memory 704 and/or within the system processor 702 during execution thereof by the computer system 700, the main memory 704 and the system processor 702 also constituting machine-readable storage media. The software 722 may further be transmitted or received over a network 720 via the system network interface device 708. In an embodiment, the network interface device 708 may operate using RF coupling, optical coupling, acoustic coupling, or inductive coupling.

While the machine-accessible storage medium 732 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

In the foregoing specification, specific exemplary embodiments have been described. It will be evident that various modifications may be made thereto without departing from the scope of the following claims. The specification and drawings are, accordingly, to be regarded in an illustrative sense rather than a restrictive sense.

What is claimed is:

1. A method of modeling a rapid thermal processing (RTP) tool, comprising:
developing a lamp model of an RTP tool, wherein the lamp model comprises a plurality of lamp zones;
calculating an irradiance graph for the plurality of lamp zones;
multiplying irradiance values of the plurality of lamp zones in the irradiance graph by a power of an existing RTP tool at a given time during a process recipe;
summing the multiplied irradiance values for the plurality of lamp zones to form an irradiation graph of the lamp model;
using the irradiation graph as an input to a machine learning algorithm; and
outputting the temperature across a hypothetical substrate from the machine learning algorithm.

2. The method of claim 1, further comprising:
training the machine learning algorithm with training data that includes real temperature data from the existing RTP tool.

3. The method of claim 2, wherein the training includes at least 25 sets of different training data.

4. The method of claim 1, wherein the plurality of lamp zones includes up to 15 lamp zones.

5. The method of claim 1, wherein a lamp arrangement of the lamp model is different than a lamp arrangement of the existing RTP tool.

6. The method of claim 5, wherein a number of lamps in the lamp arrangement of the lamp model is different than a number of lamps in the lamp arrangement of the existing RTP tool.

7. The method of claim 1, wherein the machine learning algorithm comprises two or more hidden layers.

8. The method of claim 1, wherein the irradiation graph includes data points for at least 15 different positions on the hypothetical substrate.

9. The method of claim 1, wherein the given time during a process recipe is during a thermal soak.

10. The method of claim 1, wherein the given time during the process recipe is during a thermal ramp.

11. The method of claim 1, wherein the temperature across the hypothetical substrate substantially matches a set of training data.

12. A non-transitory computer readable medium containing program instructions for causing a computer to perform the method comprising:
developing a lamp model of an RTP tool, wherein the lamp model comprises a plurality of lamp zones;
calculating an irradiance graph for the plurality of lamp zones;
multiplying irradiance values of the plurality of lamp zones in the irradiance graph by a power of an existing RTP tool at a given time during a process recipe;
summing the multiplied irradiance values for the plurality of lamp zones to form an irradiation graph of the lamp model;
using the irradiation graph as an input to a machine learning algorithm; and
outputting the temperature across a hypothetical substrate from the machine learning algorithm.

13. The non-transitory computer readable medium of claim 12, further comprising:
training the machine learning algorithm with training data that includes real temperature data from the existing RTP tool.

14. The non-transitory computer readable medium of claim 13, wherein the training includes at least 25 sets of different training data.

15. The non-transitory computer readable medium of claim 12, wherein the plurality of lamp zones includes up to 15 lamp zones.

16. The non-transitory computer readable medium of claim 12, wherein a lamp arrangement of the lamp model is different than a lamp arrangement of the existing RTP tool.

17. The non-transitory computer readable medium of claim 16, wherein a number of lamps in the lamp arrangement of the lamp model is different than a number of lamps in the lamp arrangement of the existing RTP tool.

18. The method of claim 1, wherein the given time during a process recipe is during a thermal soak and/or during a thermal ramp.

19. A method of modeling a rapid thermal processing (RTP) tool, comprising:
training a machine learning algorithm with training data that includes real temperature data from an existing RTP tool;
developing a lamp model of an RTP tool, wherein the lamp model comprises a plurality of lamp zones, and wherein a number of lamps in the lamp model is different than a number of lamps in the existing RTP tool;
calculating an irradiance graph for the plurality of lamp zones;
multiplying irradiance values of the plurality of lamp zones in the irradiance graph by a power of the existing RTP tool at a given time during a process recipe;
summing the multiplied irradiance values for the plurality of lamp zones to form an irradiation graph of the lamp model;
using the irradiation graph as an input to the machine learning algorithm; and
outputting the temperature across a hypothetical substrate from the machine learning algorithm.

20. The method of claim 19, wherein the given time during a process recipe is during a thermal soak and/or a thermal ramp.
